(19) United States
(12) Patent Application Publication
(10) Pub. No.: US 2025/0372112 A1
(43) Pub. Date: Dec. 4, 2025

(54) REVERBERATION CANCELLATION FRAMEWORK

(71) Applicant: Google LLC, Mountain View, CA (US)

(72) Inventor: Dongeek Shin, San Jose, CA (US)

(21) Appl. No.: 19/101,189

(22) PCT Filed: Dec. 18, 2023
(86) PCT No.: PCT/US2023/084601

§ 371 Date: Feb. 4, 2025

(51) Int. Cl. G10L 21/0232; G10L 21/0208; G10L 21/10; G10L 25/18; G10L 25/30

(52) U.S. Cl. CPC G10L 21/0232; G10L 21/10; G10L 25/18; G10L 25/30; G10L 2021/02082

(57) ABSTRACT

Systems and techniques for a reverberation cancellation framework include receiving a far-field audio signal from a far-field microphone array and a near-field audio signal from a near-field microphone array, where the far-field microphone array is a greater distance from an audio source than the near-field microphone array. The far-field audio signal and the near-field audio signal are synchronized. The far-field audio signal and the near-field audio signal are encoded to remove noise artifacts from the far-field audio signal and the near-field audio signal. The far-field audio signal and the near-field audio signal are decoded to output an output audio signal with the noise artifacts removed.

### TECHNICAL FIELD

This description relates to a reverberation cancellation framework.

### BACKGROUND

In an example teleconferencing setting, with or without video, various factors may affect the quality of the sound captured from a speaker and transmitted to a listener. One factor is reverberation, also referred to interchangeably throughout as reverb. Reverberation or reverb may occur when the speaker is in a spacious room. A result of reverb includes the speaker's speech accompanied by echoing sounds that are heard by the listener. It is desirable for the listener to receive and hear clean speech (i.e., free from audio defects like reverb) from the speaker.

### SUMMARY

This document describes systems and techniques for reducing and/or eliminating the effects of reverb. A reverb cancellation framework includes a combination of a microphone arrangement, e.g., associated with a conference system (with or without video) and one or more microphones associated with other devices (e.g., a phone, a watch, an earbud, a voice-assistant device, a laptop, etc.). The microphone arrangement associated with the audio conference system may be a far-field microphone arrangement and the one or more microphones associated with the other devices may be a near-field microphone arrangement. The reverb cancellation framework synchronizes the audio from the far-field microphone arrangement and the near-field microphone arrangement. The synchronized audio from the far-field microphone arrangement and the near-field microphone arrangement may be processed by a multi-head, speech enhancement network to output reverb-free speech that is transmitted to the listener.

In some aspects, the techniques described herein relate to a method including: receiving a far-field audio signal from a far-field microphone arrangement and a near-field audio signal from a near-field microphone arrangement, the far-field microphone arrangement being at a greater distance from an audio source than the near-field microphone arrangement; synchronizing the far-field audio signal and the near-field audio signal; encoding the far-field audio signal and the near-field audio signal to remove noise artifacts from the far-field audio signal and the near-field audio signal; and decoding the far-field audio signal and the near-field audio signal to output an output audio signal with the noise artifacts removed.

In some aspects, the techniques described herein relate to a computer program product, the computer program product being tangibly embodied on a non-transitory computer-readable medium and including instructions that, when executed by at least one computing device, are configured to cause the at least one computing device to: receive a far-field audio signal from a far-field microphone arrangement and a near-field audio signal from a near-field microphone arrangement, the far-field microphone arrangement being at a greater distance from an audio source than the near-field microphone arrangement; synchronize the far-field audio signal and the near-field audio signal; encode the far-field audio signal and the near-field audio signal to remove noise artifacts from the far-field audio signal and the near-field audio signal; and decode the far-field audio signal and the near-field audio signal to output an output audio signal with the noise artifacts removed.

In some aspects, the techniques described herein relate to a system, including: at least one processor; and a non-transitory computer-readable medium including instructions that, when executed by the at least one processor, cause the system to implement a synchronization module, an encoder module, and a decoder module, wherein: the synchronization module is configured to: receive a far-field audio signal from a far-field microphone arrangement and a near-field audio signal from a near-field microphone arrangement, the far-field microphone arrangement being at a greater distance from an audio source than the near-field microphone arrangement, and synchronize the far-field audio signal and the near-field audio signal; the encoder module is configured to encode the far-field audio signal and the near-field audio signal to remove noise artifacts from the far-field audio signal and the near-field audio signal; and the decoder module is configured to decode the far-field audio signal and the near-field audio signal to output an output audio signal with the noise artifacts removed.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a system for a reverberation cancellation framework.

FIG. 2 is a block diagram of an example teleconference system.

FIG. 3 is an example block diagram of the encoder module of FIG. 1.

FIG. 4 is an example block diagram of the decoder module of FIG. 1.

FIG. 5 is a flowchart illustrating example operations of the system of FIG. 1.

### DETAILED DESCRIPTION

This document describes technical solutions to technical problems associated with reverberation in an audio conference system. As discussed above, reverberation may occur when a speaker is in a spacious room and the array of microphones associated with the audio conference system are at a large distance from the speaker. An effect of the reverb is to output a speech signal that includes echoing audio sounds. The speech signals with the echoing audio sounds are transmitted to and heard by the listener. The technical solutions include systems and techniques to eliminate and/or reduce the reverb. That is, the technical solutions include a reverb cancellation framework that cancels the reverb and removes the effects of the echoing audio sounds from the speech. The technical effect is to output and produce reverb-free (or near reverb-free) speech from a speaker to a listener.

The reverb cancellation framework includes a combination of a microphone arrangement associated with an audio conference system (with or without video) and one or more microphones associated with other devices (e.g., a phone, a watch, an earbud, a voice-assistant device, a laptop, etc.). The microphone arrangement associated with the audio conference system may be a far-field microphone arrangement and the one or more microphones associated with the other devices may be a near-field microphone arrangement. The reverb cancellation framework synchronizes the audio from the far-field microphone arrangement and the near-field microphone arrangement. The synchronized audio from the far-field microphone arrangement and the near-field microphone arrangement is processed by a multi-head, speech enhancement network to output reverb-free speech that is transmitted to the listener.

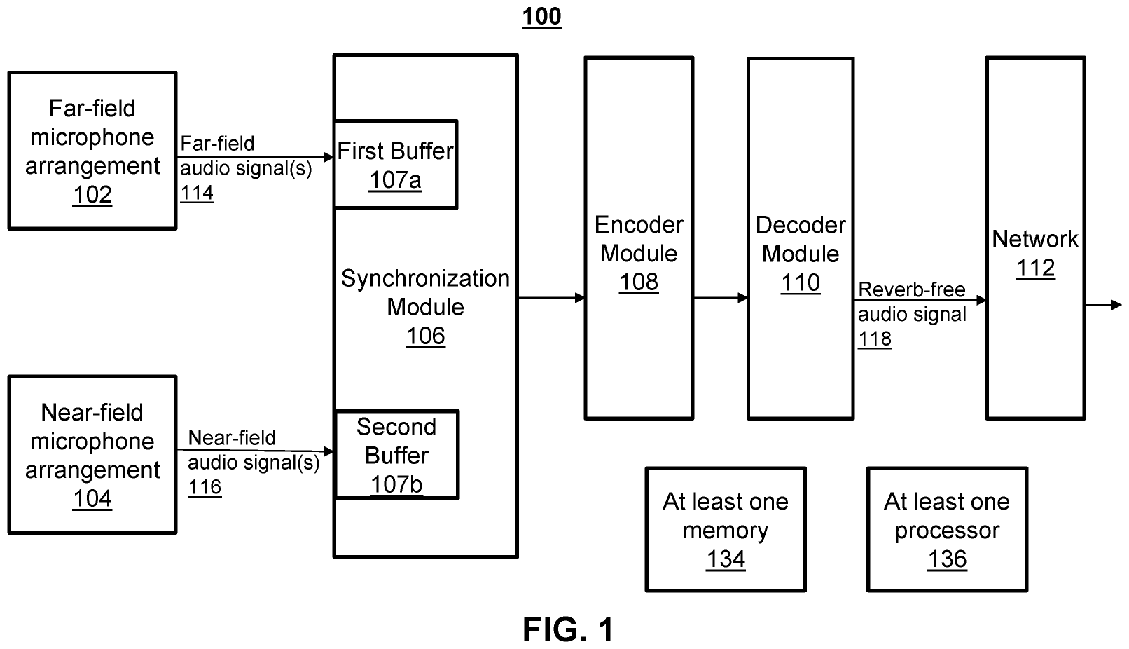

FIG. 1 is a block diagram of a system 100 for a reverberation cancellation framework. The system 100 includes a far-field microphone arrangement 102 and a near-field microphone arrangement 104. The system 100 includes a synchronization module 106, an encoder module 108, a decoder module 110, and a network 112. In general, the system 100 is configured to receive far-field audio signals 114 from the far-field microphone arrangement 102 and near-field audio signals 116 from the near-field microphone arrangement 104 and to output a reverb-free audio signal 118. For example, the far-field microphone arrangement 102 may capture far-field audio signals 114 from an audio source, such as a speaker. The near-field microphone arrangement 104 may capture near-field audio signals 116 from the same audio source, such as the same speaker. The far-field audio signals 114 and the near-field audio signals 116 are processed by the synchronization module 106, the encoder module 108, and the decoder module 110 to output the reverb-free audio signal 118, as described in more detail below.

The system 100 also includes at least one memory 134 and at least one processor 136. The at least one processor 136 may represent two or more processors in the system 100 executing in parallel and utilizing corresponding instructions stored using the at least one memory 134. The at least one processor 136 may include at least one central processing unit (CPU). The at least one memory 134 represents a non-transitory computer-readable storage medium. Of course, similarly, the at least one memory 134 may represent one or more different types of memory utilized by the system 100. In addition to storing instructions, which allow the at least one processor 136 to implement the system 100 and its various components, the at least one memory 134 may be used to store data and other information used by and/or generated by the system 100 and its components.

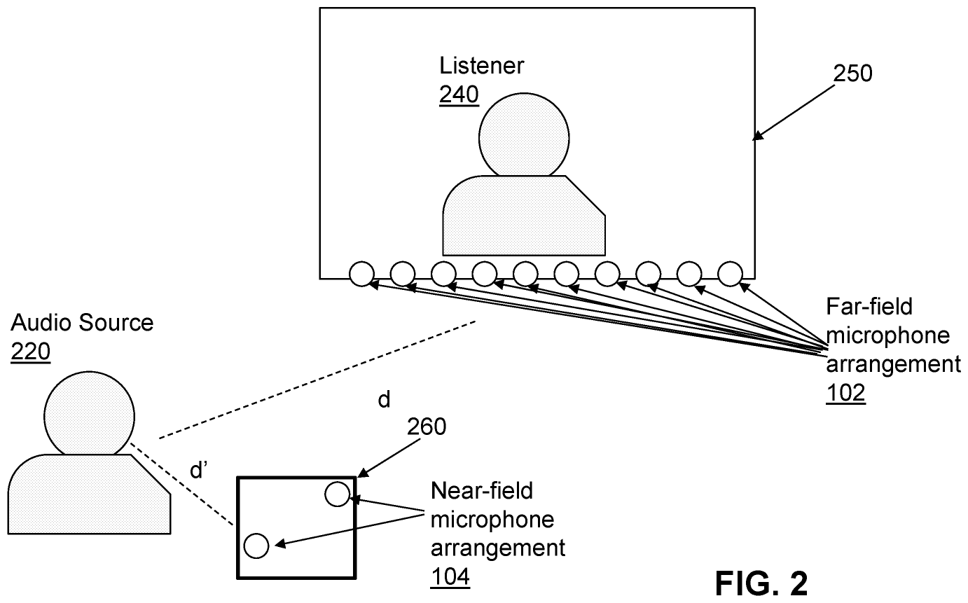

FIG. 2 depicts an audio source 220. In this example, the audio source 220 may be a person and may be referred to as the speaker. The audio source 220, in this case the speaker, may be communicating with a listener 240 over a teleconference system 250. The teleconference system 250 may be capable of receiving, transmitting, playing, and displaying both audio and video signals. In some implementations, the teleconference system 250 may be capable of receiving, transmitting, and playing audio signals without video signals.

The teleconference system 250 includes the far-field microphone arrangement 102, which is the same far-field microphone arrangement 102 of FIG. 1. The far-field microphone arrangement 102 captures the audio signals from the audio source 220, including speech. The audio signals captured by the far-field microphone arrangement 102 may be referred to as the far-field audio signals 114, as also referred to in FIG. 1. The far-field microphone arrangement 102 may include one or more microphones (e.g., one, two, three, four, five, six, etc.). The far-field microphone arrangement 102 may include high quality microphones. That is, the far-field microphone arrangement 102 may include hi-fidelity microphones.

In this example, a device 260 may include the near-field microphone array 204, which is the same near-field microphone arrangement 104 of FIG. 1. The near-field microphone arrangement 104 also captures the audio signals from the audio source 220, including speech. The audio signals captured by the near-field microphone arrangement 104 may be referred to as the near-field audio signals 116, as also referred to in FIG. 1. The near-field microphone arrangement 104 may include one or more microphones (e.g., one, two, three, four, five, six, etc.). The near-field microphone arrangement 104 may include low quality microphones. That is, the near-field microphone arrangement 104 may include low-fidelity microphones.

The device 260 includes a computing device that includes the near-field microphone arrangement 104 having one or more microphones. For example, the device 260 may include a phone, a watch, an earbud, a voice-assistant device, a laptop, or the like. In some implementations, the near-field microphone arrangement 104 in the device 260 is always-on or at least nearly always-on. This means that the device 260 may be capable of capturing the near-field audio signals 116 without being specifically activated by the user. That is, as long as the device 260 is turned on and not placed in a mode not to capture the near-field audio signals 116, then the device 260 will be capable of capturing the near-field audio signals 116.

In some implementations, the quality and fidelity of the microphones in the far-field microphone arrangement 102 and the microphones in the near-field microphone arrangement 104 are relative to each other. For example, the far-field microphone arrangement 102 may include higher quality and/or higher fidelity microphones relative to the near-field microphone arrangement 104, which may include lower quality and/or lower fidelity microphones.

In some implementations, the number of microphones in the far-field microphone arrangement 102 is greater than the number of microphones in the near-field microphone arrangement 104. For example, the far-field microphone arrangement 102 may include six or more microphones and the near-field microphone arrangement 104 may include two or fewer microphones.

As illustrated in FIG. 2, the distance, d, is the distance between the audio source 220 and the far-field microphone arrangement 102. The distance, d′, is the distance between the audio source 220 and the near-field microphone arrangement 104. The distance, d, is greater than the distance, d′. That is, the far-field microphone arrangement 102 is farther away from the audio source 220 than the near-field microphone arrangement 104. Said another way, the near-field microphone arrangement 104 is closer to the audio source 220 than the far-field microphone arrangement 102. In this manner, the audio signals from the audio source 220 will be received by and captured by the near-field microphone arrangement 104 sooner or earlier in time than the far-field microphone arrangement 102. Said another way, there is a time delay or a difference in time between the time that the audio signals from the audio source 220 reach the far-field microphone arrangement 102 compared to the time that the audio signals from the audio source 220 reach the near-field microphone arrangement 104.

In one use example, the audio source 220 may be the speaker in a teleconference using the teleconference system 250. The far-field microphone arrangement 102 is on the teleconference system 250 at a distance, d, from the speaker. The device 260 may be the speaker's phone on a table near the speaker. The phone includes the near-field microphone arrangement 104 that is integrated as part of the phone. The near-field microphone arrangement 104 is at a distance, d′, from the speaker. Other use examples may be similar but the device 260 may be a device other than the speaker's phone such as, for example, such as a tablet computer, a laptop computer, a home assistant device, or other type of computing device.

Without the system 100 of FIG. 1, meaning with only the far-field microphone arrangement 102 and without the near-field microphone arrangement 104 and without the other components of FIG. 1, the non-direct audio peaks of the audio signals from the audio source 220 become very noticeable and audible to the listener 240 because of the high room reverb effects due to the distance, d. In contrast, with the system 100, including the near-field microphone arrangement 104 and the other components of FIG. 1, the effects of the high room reverb can be cancelled and eliminated, at least to the extent that there is a reduced or even no noticeable reverb effect and a reduced or even no noticeable audible effect to the listener 240.

Referring to both FIG. 1 and FIG. 2, the far-field microphone arrangement 102 receives and captures the audio signals from the audio source 220 and the near-field microphone arrangement 104 receives and captures the audio signals from the audio source 220. The audio signals captured by the far-field microphone arrangement 102 are referred to as far-field audio signals 114 and the audio signals captured by the near-field microphone arrangement 104 are referred to as near-field audio signals 116. Both the far-field audio signals 114 and the near-field audio signals 116 are input to the synchronization module 106.

The synchronization module 106 receives the far-field audio signals 114 and the near-field audio signals 116. Because there is a delay due to the distances between the audio source 220 and the far-field microphone arrangement 102 and the audio source 220 and the near-field microphone arrangement 104, the synchronization module 106 is configured to synchronize the far-field audio signals 114 and the near-field audio signals 116 to remove the time delay so that the far-field audio signals 114 and the near-field audio signals 116 can be processed to remove the noise, including any audio effects due to reverb. Additionally, because the teleconference system 250 and the device 260 have different system clocks, the synchronization module 106 is configured to synchronize the far-field audio signals 114 and the near-field audio signals 116.

The synchronization module 106 may include one or more buffers to buffer the far-field audio signals 114 and the near-field audio signals 116 for synchronization. For example, the synchronization module 106 may include a first buffer 107a and a second buffer 107b. The first buffer 107a may store the far-field audio signals 114 and the second buffer 107b may store the near-field audio signals 116. In some implementations, the first buffer 107a and the second buffer 107b may be portions of a single buffer. In some implementations, the first buffer 107a and the second buffer 107b may be separate buffers. After buffering the far-field audio signals 114 and the near-field audio signals 116, the synchronization module 106 aligns the far-field audio signals 114 and the near-field audio signals 116 such that the far-field audio signals 114 and the near-field audio signals 116 are synchronized.

In some implementations, the synchronization module 106 may use an unsupervised machine learning module or other unsupervised method to align the audio features, including the speech features, from the far-field audio signals 114 and the near-field audio signals 116. For example, when the audio source 220 is a speaker, the speech from the speaker that is captured by the far-field microphone arrangement 102 and the near-field microphone arrangement 104 and that is recorded and buffered by the synchronization module 106, is aligned so that the timing of the far-field audio signals 114 and the near-field audio signals 116 match.

In some implementations, the synchronization module 106 may use a type of cross-device communications to align the far-field audio signals 114 and the near-field audio signals 116. For example, the synchronization module 106 may use protocols such as Bluetooth low energy (BLE) or Wi-Fi Direct to coordinate the alignment of the far-field audio signals 114 and the near-field audio signals 116.

In some implementations, a pattern in the far-field audio signals 114 may be matched with a pattern in the near-field audio signals 116. To synchronize the audio features, including the speech features, from the far-field audio signals 114 and the near-field audio signals 116, one of the far-field audio signals 114 or the near-field audio signals 116 may be delayed by a time determined by the synchronization module 106.

The synchronization module 106 sends the synchronized far-field audio signals 114 and the near-field audio signals 116 to the encoder module 108. The encoder module 108 receives the synchronized far-field audio signals 114 and near-field audio signals 116. The far-field audio signals 114 and the near-field audio signals 116 are in the time domain. The encoder module 108 is configured to transform the far-field audio signals 114 and the near-field audio signals 116 to the frequency domain or spectral domain.

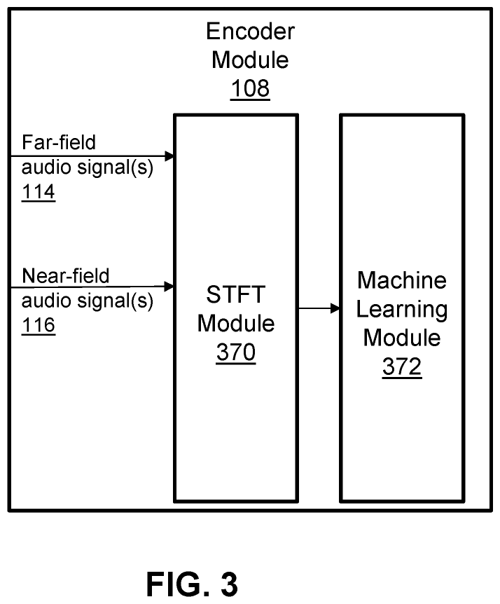

Referring to FIG. 3, in some implementations, the encoder module 108 includes a short-time Fourier transform (STFT) module 370. The STFT module 370 includes one or more STFT blocks that are configured to transform the synchronized far-field audio signals 114 and the near-field audio signals 116 from the time domain to the frequency domain. The output from the STFT module 370 is representations of the far-field audio signals 114 and the near-field audio signals 116 as spectrograms. The spectrograms are visual representations (e.g., images) of the spectrum of frequencies represented by the original synchronized, time domain far-field audio signals 114 and the near-field audio signals 116. For example, the spectrograms show an intensity of the respective signal versus frequency and time. The spectrograms are processed by a machine learning module 372 that is part of the encoder module 108.

The machine learning module 372 is configured to process the spectrograms to remove the noise artifacts, including the reverb, and to combine the far-field audio signals 114 and the near-field audio signals 116 into a single, reverb-free audio signal. In some implementations, machine learning module 372 is trained with training data comprising spectrograms of far-field audio signals 114 and the near-field audio signals 116 including reverb (or other noise artifacts), and with training data comprising spectrograms of far-field audio signals 114 and the near-field audio signals 116 not including reverb (or other noise artifacts). In some implementations, the machine learning module 372 is a convolutional neural network (CNN). In some implementations, the CNN is a U-Net, where the U-Net is a custom U-Net that is custom-trained to output a visual representation of the audio signal from the audio source 220 that is reverb-free. In some implementations, the CNN is a Mark R-CNN, where the Mark R-CNN is a custom Mark-R CNN that is custom-trained to output a visual representation of the audio signal from the audio source 220 that is reverb-free.

In these implementations, the CNN includes multiple convolutional layers (e.g., multi-head attention layers) in which the desired spatial properties are extracted from the spectrograms. For example, the far-field audio signals 114 from the far-field microphone arrangement 102 may include accurate beam steering properties and high-frequency, intelligibility properties of user speech. These desired properties are extracted from the spectrograms representing the far-field audio signals 114. The undesirable properties, including the reverb and other noise properties, from the spectrograms representing the far-field audio signals 114 are not extracted.

The near-field audio signals 116 from the near-field microphone arrangement 104 may include speech properties with good audio masks with accurate subtraction of room models. These desired properties are extracted from the spectrograms representing the near-field audio signals 116. Any undesirable properties from the spectrograms representing the near-field audio signals 116 are not extracted.

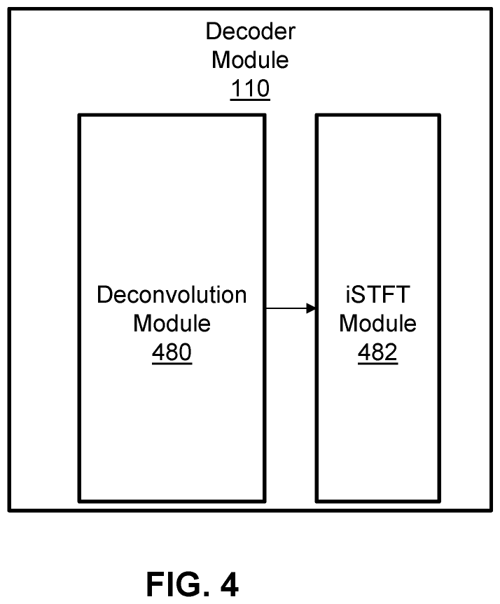

The encoder module 108 extracts the desired properties (or features) and encodes the desired properties. The encoded output of the encoder module 108 is then communicated to the decoder module 110. Referring to FIG. 4, the decoder module 110 includes a deconvolution module 480 and an inverse STFT (iSTFT) module 482. The deconvolution module 480 converts the output of the encoder module 108 back to an image frequency representation that is accurate in reverb cancellation but still maintains the desired properties and qualities of the audio signal, including the speech. The iSTFT module 482 performs an inverse transformation to transform the image frequency representation (e.g., spectral domain features) back to a time domain output of the audio signal with reverb cancellation, that is the reverb-free audio signal 118.

Referring back to FIG. 1, the reverb-free audio signal 118 is communicated over the network 112 where it may be received on the other end of the teleconference system 250 and heard by the listener 240.

In some implementations, the synchronization module 106, the encoder module 108, and the decoder module 110 may be implemented as part of the teleconference system 250. That is, these components perform processing of their functions using memory and at least one processor on the teleconference system 250.

In some implementations, the synchronization module 106, the encoder module 108, and the decoder module 110 may be implemented and split between the teleconference system 250 and the device 260. For example, each of the teleconference system 250 and the device 260 may include an encoder module 108 to process the respective far-field audio signals 114 on the teleconference system 250 and the near-field audio signals 116 on the device 260, either before or after being synchronized by a synchronization module 106. In this example, the encoder module 108 on each of the teleconference system 250 and the device 260 may perform its functions and then a synchronization module 106 on either the teleconference system 250 or the device 260 may synchronize the output of the encoder module 108.

In some implementations, the decoder module 110 may be implemented after the network 112. That is, the output of the encoder module 108 may be communicated over the network 112 and then a decoder module 110 on the listener side of the network 112 may perform the decoding functions to output the reverb-free audio signal 118 for the listener.

In some implementations, the encoder module 108, which includes the machine learning module 372, may be trained using a supervised machine learning process. For example, the machine learning module 372 may be trained using a high-fidelity microphone near the audio source 220 as a ground truth. In this manner, the output of the audio source 220 using a high fidelity microphone can be used as a labelled ground truth to train the encoder module 108 to eliminate the reverb from the far-field audio signals 114.

In some implementations, the near-field microphone arrangement 104 may include microphones from multiple, different devices. That is the device 260 may represent multiple devices that are near the audio source 220. The microphones from the multiple devices may contribute to and be considered a part of the near-field microphone arrangement 104.

Additionally, if the device 260 represents multiple devices, a threshold of audio energy may be used to determine whether or not to include the microphones from a particular device as part of the near-field microphone arrangement 104. That is, a device may be too far from the audio source 220 or may be moved away from the audio source 220 such that it does not contribute enough.

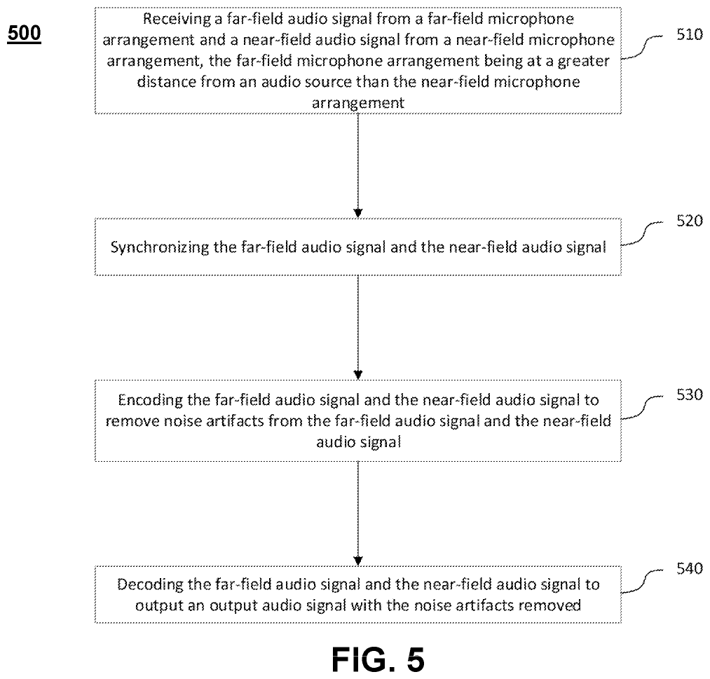

FIG. 5 illustrates an example process 500 for using the system 100 of FIG. 1. Process 500 is a computer-implemented method that may be implemented by the system 100 of FIG. 1, including the synchronization module 106, the encoder module 108, and the decoder module 110. Instructions and/or executable code for the process 500 may be stored in the at least one memory 134, and the stored instructions may be executed by the at least one processor 136. Process 500 is also illustrative of a computer program product that may be implemented by the system 100 of FIG. 1.

Process 500 includes receiving a far-field audio signal from a far-field microphone arrangement and a near-field audio signal from a near-field microphone arrangement, the far-field microphone arrangement being at a greater distance from an audio source than the near-field microphone arrangement (510). For example, the synchronization module 106 of FIG. 1 is configured to receive a far-field audio signal from a far-field microphone arrangement and a near-field audio signal from a near-field microphone arrangement, the far-field microphone arrangement being at a greater distance from an audio source than the near-field microphone arrangement.

Process 500 includes synchronizing the far-field audio signal and the near-field audio signal (520). For example, the synchronization module 106 of FIG. 1 is configured to synchronize the far-field audio signal and the near-field audio signal.

Process 500 includes encoding the far-field audio signal and the near-field audio signal to remove noise artifacts from the far-field audio signal and the near-field audio signal (530). For example, the encoder module 108 is configured to encode the far-field audio signal and the near-field audio signal to remove noise artifacts from the far-field audio signal and the near-field audio signal.

Process 500 includes decoding the far-field audio signal and the near-field audio signal to output an output audio signal with the noise artifacts removed (540). For example, the decoder module 110 of FIG. 1 is configured to decode the far-field audio signal and the near-field audio signal to output an output audio signal with the noise artifacts removed.

### EXAMPLES

Example 1: A method comprising: receiving a far-field audio signal from a far-field microphone arrangement and a near-field audio signal from a near-field microphone arrangement, the far-field microphone arrangement being at a greater distance from an audio source than the near-field microphone arrangement; synchronizing the far-field audio signal and the near-field audio signal: encoding the far-field audio signal and the near-field audio signal to remove noise artifacts from the far-field audio signal and the near-field audio signal; and decoding the far-field audio signal and the near-field audio signal to output an output audio signal with the noise artifacts removed.

Example 2: The method of Example 1, wherein encoding the far-field audio signal and the near-field audio signal comprises: transforming the far-field audio signal and the near-field audio signal into image representations of the far-field audio signal and the near-field audio signal; and processing the image representations through a machine learning module to output encoded audio signals with the noise artifacts removed.

Example 3: The method of Example 2, wherein the machine learning module is a convolutional neural network.

Example 4: The method of Example 2 or 3, wherein transforming the far-field audio signal and the near-field audio signal comprises performing a short-time Fourier transform on the far-field audio signal and the near-field audio signal to output the image representations of the far-field audio signal and the near-field audio signal.

Example 5: The method of any one of Examples 2 to 4, wherein decoding the far-field audio signal and the near-field audio signal comprises: converting the encoded audio signals to image representations with the noise artifacts removed; and performing an inverse short-time Fourier transform on the image representations with the noise artifacts removed into the output audio signal with the noise artifacts removed.

Example 6: The method of any one of Examples 1 to 5, wherein the noise artifacts include reverberation.

Example 7: The method of any one of Examples 1 to 6, wherein the near-field microphone arrangement includes one or more microphones on at least one of a phone, a tablet, an earbud, or a home assistant device.

Example 8: The method of any one of Examples 1 to 6, wherein the far-field microphone arrangement is an array of a plurality of microphones.

Example 9: A system comprising: at least one processor and memory storing instructions that, when executed by the at least one processor, causes the system to perform the operations of any of Examples 1 to 8.

Example 10: A system comprising: at least one processor and memory storing instructions that, when executed by the at least one processor, causes the system to perform any of the operations or methods disclosed herein.

Example 11: A non-transitory computer-readable medium storing instructions that, when executed by at least one processor, causes a computing system to perform any of the operations or methods disclosed herein.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry. e.g., an FPGA (field programmable gate array) or an ASIC (application-specific integrated circuit).

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims. Moreover, as used herein, ‘a’ or ‘an’ entity may refer to one or more of that entity.

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes, and equivalents will now occur to those skilled in the art. It is, therefore, to be understood that the appended claims are intended to cover all such modifications and changes as fall within the scope of the embodiments.

1. A method comprising:
receiving a far-field audio signal from a far-field microphone arrangement and a near-field audio signal from a near-field microphone arrangement, the far-field microphone arrangement being at a greater distance from an audio source than the near-field microphone arrangement;
synchronizing the far-field audio signal and the near-field audio signal;
encoding the far-field audio signal and the near-field audio signal to remove noise artifacts from the far-field audio signal and the near-field audio signal; and
decoding the far-field audio signal and the near-field audio signal to output an output audio signal with the noise artifacts removed.

2. The method of claim 1, wherein encoding the far-field audio signal and the near-field audio signal comprises:
transforming the far-field audio signal and the near-field audio signal into image representations of the far-field audio signal and the near-field audio signal; and
processing the image representations through a machine learning module to output encoded audio signals with the noise artifacts removed.

3. The method of claim 2, wherein the machine learning module is a convolutional neural network.

4. The method of claim 2, wherein transforming the far-field audio signal and the near-field audio signal comprises performing a short-time Fourier transform on the far-field audio signal and the near-field audio signal to output the image representations of the far-field audio signal and the near-field audio signal.

5. The method of claim 2, wherein decoding the far-field audio signal and the near-field audio signal comprises:
converting the encoded audio signals to image representations with the noise artifacts removed; and
performing an inverse short-time Fourier transform on the image representations with the noise artifacts removed into the output audio signal with the noise artifacts removed.

6. The method of claim 1, wherein the noise artifacts include reverberation.

7. The method of claim 1, wherein the near-field microphone arrangement includes one or more microphones on at least one of a phone, a tablet, an earbud, or a home assistant device.

8. The method of claim 1, wherein the far-field microphone arrangement is an array of a plurality of microphones.

9. A computer program product, the computer program product being tangibly embodied on a non-transitory computer-readable medium and comprising instructions that, when executed by at least one computing device, are configured to cause the at least one computing device to:
receive a far-field audio signal from a far-field microphone arrangement and a near-field audio signal from a near-field microphone arrangement, the far-field microphone arrangement being at a greater distance from an audio source than the near-field microphone arrangement;
synchronize the far-field audio signal and the near-field audio signal;
encode the far-field audio signal and the near-field audio signal to remove noise artifacts from the far-field audio signal and the near-field audio signal; and
decode the far-field audio signal and the near-field audio signal to output an output audio signal with the noise artifacts removed.

10. The computer program product of claim 9, wherein encoding the far-field audio signal and the near-field audio signal comprises instructions that, when executed by the at least one computing device, are configured to cause the at least one computing device to:
transform the far-field audio signal and the near-field audio signal into image representations of the far-field audio signal and the near-field audio signal; and
process the image representations through a machine learning module to output encoded audio signals with the noise artifacts removed.

11. The computer program product of claim 10, wherein the machine learning module is a convolutional neural network.

12. The computer program product of claim 10, wherein transforming the far-field audio signal and the near-field audio signal comprises instructions that, when executed by the at least one computing device, are configured to cause the at least one computing device to perform a short-time Fourier transform on the far-field audio signal and the near-field audio signal to output the image representations of the far-field audio signal and the near-field audio signal.

13. The computer program product of claim 10, wherein decoding the far-field audio signal and the near-field audio signal comprises instructions that, when executed by the at least one computing device, are configured to cause the at least one computing device to:
convert the encoded audio signals to image representations with the noise artifacts removed; and
perform an inverse short-time Fourier transform on the image representations with the noise artifacts removed into the output audio signal with the noise artifacts removed.

14. The computer program product of claim 9, wherein the noise artifacts include reverberation.

15. The computer program product of claim 9, wherein the near-field microphone arrangement includes one or more microphones on at least one of a phone, a tablet, an earbud, or a home assistant device.

16. The computer program product of claim 9, wherein the far-field microphone arrangement is an array of a plurality of microphones.

17. A system, comprising:
at least one processor; and
a non-transitory computer-readable medium comprising instructions that, when executed by the at least one processor, cause the system to implement a synchronization module, an encoder module, and a decoder module, wherein:
the synchronization module is configured to:
receive a far-field audio signal from a far-field microphone arrangement and a near-field audio signal from a near-field microphone arrangement, the far-field microphone arrangement being at a greater distance from an audio source than the near-field microphone arrangement, and
synchronize the far-field audio signal and the near-field audio signal;
the encoder module is configured to encode the far-field audio signal and the near-field audio signal to remove noise artifacts from the far-field audio signal and the near-field audio signal; and
the decoder module is configured to decode the far-field audio signal and the near-field audio signal to output an output audio signal with the noise artifacts removed.

18. The system of claim 17, wherein the encoder module is configured to:
transform the far-field audio signal and the near-field audio signal into image representations of the far-field audio signal and the near-field audio signal; and
process the image representations through a machine learning module to output encoded audio signals with the noise artifacts removed.

19. The system of claim 18, wherein the machine learning module is a convolutional neural network.

20. The system of claim 18, wherein the encoder module is configured to perform a short-time Fourier transform on the far-field audio signal and the near-field audio signal to output the image representations of the far-field audio signal and the near-field audio signal.

21. The system of claim 18, wherein the decoder module is configured to:
convert the encoded audio signals to image representations with the noise artifacts removed; and
perform an inverse short-time Fourier transform on the image representations with the noise artifacts removed into the output audio signal with the noise artifacts removed.

22. The system of claim 17, wherein the noise artifacts include reverberation.

23. The system of claim 17, wherein the near-field microphone arrangement includes one or more microphones on at least one of a phone, a tablet, an earbud, or a home assistant device.

24. The system of claim 17, wherein the far-field microphone arrangement is an array of a plurality of microphones.
